(19) United States
(12) Patent Application Publication
(10) Pub. No.: US 2009/0073376 A1
(43) Pub. Date: Mar. 19, 2009

(54) Flip up safety, magnificaition or reading glasses

(76) Inventor: Thomas Arthor Swift, Greenwich, CT (US)

Correspondence Address: Tom Swift, 25 North Sound Beach Avenue, Riverside, CT, 06878, US

(21) Appl. No.: 11/901,348

(22) Filed: Sep. 18, 2007

(51) Int. Cl. G02C 9/02

(52) U.S. Cl. 351/59

(57) ABSTRACT

The invention relates generally to the field of reading glasses with safety as a factor in many cases where these glasses are used during the work day. The lenses are attached to a frame which is not a typical frame for glasses and frame and lenses are attached to each other by a small hinge which allows the lenses to flip up and down without removing the glasses and frame. Unlike standard reading glasses that you take off when not reading, they can become lost or broken while not on your head during work. The important feature is that while quite often a worker has one hand occupied with tools, the other hand is free to flip the lenses up or down without removing the glasses.

### DETAILED DESCRIPTION OF THE DRAWINGS

The flip up reading/safety glasses have only three components so they are very light and easy to store when not in use, folding up just as standard glasses. The glasses do not need anything other than the arms for the ear and the bridge for the nose to stay on comfortably; however, for extreme conditions or working in tight spaces, an elastic strap may be worn around the back of the head to ensure that the glasses cannot be knocked off. The strap attaches to the end of the ear arms.

Referring to FIG. 1, the arms for the ears fold the same as standard glasses and help for stabilizing the product. The nose bridge in FIGS. 1 and 2 stabilizes as well. The hinge in FIG. 1, between the earpiece and the frame, allows the ear arm to fold open or closed. The hinge in FIG. 2 allows the lens to flip up and down.

### BRIEF DESCRIPTION OF THE DRAWINGS

The accompanying drawings illustrate the simplicity of the invention as pertaining to a self-contained invention without the need for support or another structure such as is needed for a clip-on.

FIG. 1 is a side view showing the lens in the up position nose bridge and ear arms for stabilization.

FIG. 2 is a front view with the lens also in the up position.

FIG. 2 is an exploded view of the hinge which allows the lens to flip up and down.

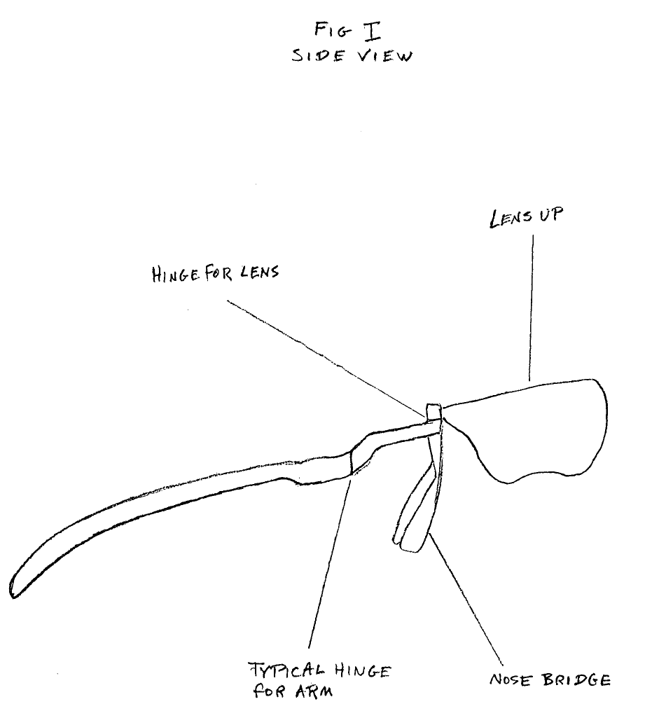

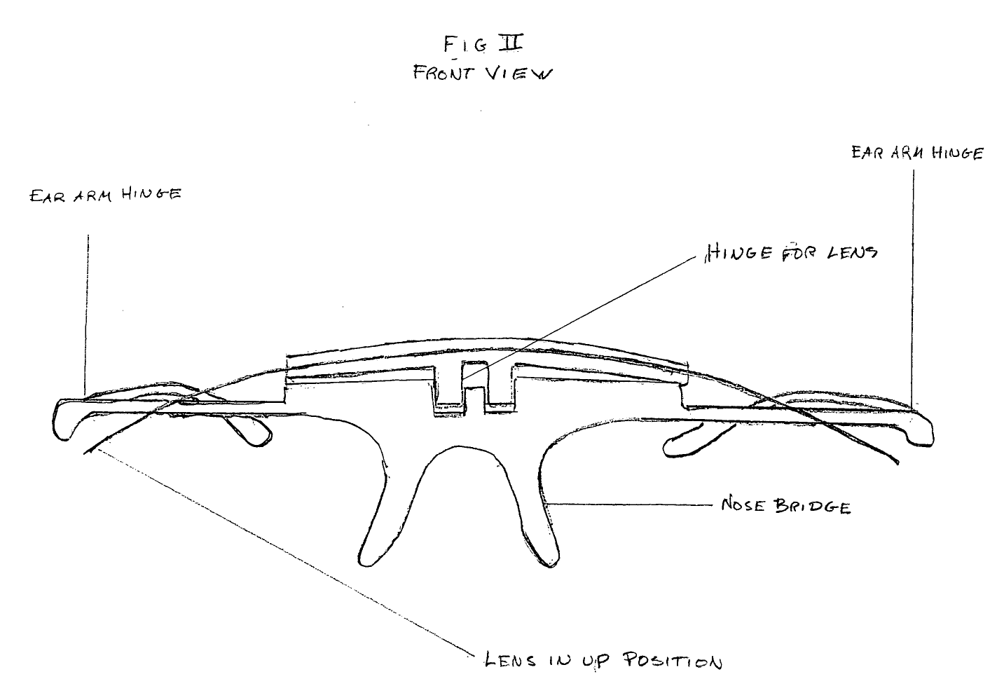

FIG. 1 is an exploded view of the arm hinge as is similar to other glasses.

1. A pair of glasses that serve as both magnification and safety for the eyes while not having to remove the glasses from the head due to the way the lenses are hinged to the frame allowing the lenses to be flipped up or down when needed or not needed with one hand, as quite often there is a tool or some situation occupying the other hand.

2. The glasses are hinged as in claim 1 in the middle of the frame but do not depend on a typical frame for support so when the lenses are flipped up there will be no lens frame around the eye to obstruct view.

3. The arms of the frame that go around the ear are typical arms that hold glasses securely on the head.

4. The hinge is mounted to the center of the nose bridge as shown in FIG. II so that it is balanced; thus, easier for one hand to operate the lens up or down.

5. The glasses do not have to be removed at any time as stated in claim 1 so they are less likely to be misplaced or broken. They are a self-contained system needing the assistance of nothing else to stay in place.
